(19) United States
(12) Patent Application Publication
(10) Pub. No.: US 2026/0086302 A1
(43) Pub. Date: Mar. 26, 2026

(54) OPTICAL ALIGNMENT APPARATUS OF OPTICAL DEVICE AND OPTICAL ALIGNMENT METHOD THEREOF

(71) Applicant: ELECTRONICS AND TELECOMMUNICATIONS RESEARCH INSTITUTE, Daejeon (KR)

(72) Inventors: Haechung Kang, Daejeon (KR); Eun Kyu Kang, Daejeon (KR); Jong Jin Lee, Daejeon (KR); Sangjin Kwon, Daejeon (KR); Won-Bae Kwon, Daejeon (KR); Myunghwan Kim, Daejeon (KR); Dae Woong Moon, Daejeon (KR); Soo Yong Jung, Daejeon (KR); Gye Sul Cho, Daejeon (KR)

(21) Appl. No.: 19/254,545

(22) Filed: Jun. 30, 2025

(30) Foreign Application Priority Data
Sep. 24, 2024 (KR) 10-2024-0129261
Dec. 23, 2024 (KR) 10-2024-0193489

(51) Int. Cl. G02B 6/42

(52) U.S. Cl. CPC G02B 6/4221; G02B 6/4227; G02B 6/4239

(57) ABSTRACT

Provided are an optical alignment apparatus and an optical alignment method. The apparatus includes a substrate mount configured to receive a mounting substrate, a transport apparatus configured to transport an optical device to be bonded to the mounting substrate, a camera provided on the substrate mount and configured to obtain an image signal of the optical device, a controller connected to the camera and configured to control a position of the optical device using the image signal, and an adhesive block portion bonded to an upper surface of the optical device and configured to provide the optical device on the mounting substrate and to be separated from optical device after bonding the mounting substrate and the optical device.

### CROSS-REFERENCE TO RELATED APPLICATIONS

This U.S. non-provisional patent application claims priority under 35 U.S.C. § 119 of Korean Patent Application Nos. 10-2024-0129261, filed on Sep. 24, 2024, and 10-2024-0193489, filed on Dec. 23, 2024, the entire contents of which are hereby incorporated by reference.

### BACKGROUND

The present disclosure herein relates to an optical system, and more particularly, to an optical alignment apparatus for bonding multi-channel optical waveguide devices and an optical alignment method thereof.

With the recent rapid development of industries of data center, artificial intelligence, etc., it is required to decrease the size, highly integrate, and increase the speed of optical transceiver modules or optical modules in order to transmit/receive a larger amount of data within a shorter time.

The optical transceiver modules may roughly include an optical sub assembly (OSA) unit and an electrical sub assembly (ESA) unit. The OSA unit may include a transmitter optical sub assembly (TOSA) for converting an electric signal into an optical signal and a receiver optical sub assembly (ROSA) for converting an optical signal into an electric signal. The EAS unit may process electric signals.

Precise optical alignment of optical devices such as a light source device (laser diode (LD)), a light reception device (photo diode (PD)), a mirror, a lens, and a waveguide in an optical transceiver module is required in order to ensure maximum optical coupling efficiency when manufacturing essential optical components such as a TOSA and ROSA.

In particular, a single mode fiber (SMF) for long-distance transmission and optical waveguides of planar waveguide circuit (PLC) devices using high refractive silica, such as an optical wavelength distribution apparatus and the like disposed in midway points in a transmission line, may be required to be designed to have a diameter of 9 μm or less. A precise optical alignment apparatus and a process method may be necessary for effectively focusing optical signals between an optical device and optical waveguides.

Furthermore, since a multisource agreement (MSA) standard for a quad small form-factor pluggable-Double Density (QSFP-DD) form factor of an optical transceiver of 1.6 Tbps level beyond 800 Gbps has been recently established, technical requirements for integrating optical devices of multiple channels such as 4 or more channels such as 8 channels and 16 channels into a limited space with a basic speed of 100 Gbps and 200 Gbps per channel increase. Accordingly, it has arisen as a main issue for productivity improvement to reduce an optical alignment process time per channel together with ensuring the precision of an optical alignment and bonding process.

A multi-channel optical module in which silicon photonics that is a representative high-integrated optical module technology may have market requirements for high integration and low cost through simplification and size reduction of an optical coupling structure. To satisfy such requirements, the multi-channel optical module may have a butt joint structure in which an optical waveguide of an optical fiber array block (FAB) and an optical waveguide of a silicon photonics device are directly bonded without using an optical focusing lens.

FIGS. 1A and 1B illustrate an example of bonding of typical optical devices 1.

Referring to FIGS. 1A and 1B, the optical devices 1 may be bonded using a bonding method for a butt joint structure. Optical waveguides 2 of the optical devices 1 may be aligned with respect to directions of six axes X, Y, Z, Rx, Ry, and Rz and may be bonded through an adhesive 3 between the optical devices 1. However, the bonding method for a butt joint structure may have bonding constraints such as mechanical impact, vibration, temperature changes, adhesive limitations, and positional errors of waveguides.

FIGS. 2A and 2B illustrate an example of bonding of typical optical devices 1.

Referring to FIGS. 2A and 2B, the optical devices 1 may be visually bonded without an alignment apparatus by using a bonding method for a surface mountable joint structure. The optical devices 1 may be provided and aligned on both sides of a mounting substrate 4. Any one of the optical devices 1 may be bonded onto the mounting substrate 4 through the adhesive 3. However, the bonding method for a surface mountable joint structure may have a limitation in ensuring reproducibility of a bonding interface gap between contact surfaces of the waveguides 2.

FIGS. 3A and 3B illustrate an example of a gripper 5 for holding the optical device 1.

Referring to FIGS. 3A and 3B, the optical device 1 may be aligned by the gripper 5. The gripper 5 may hold the optical device 1 by mechanically clapping opposing sidewalls on both sides of the optical device 1. However, the gripper 5 may cause mechanical impact, wear damage, and vibration.

FIGS. 4A and 4B illustrate an example of a vacuum collet 6 for holding the optical device 1.

Referring to FIGS. 4A and 4B, the optical device 1 may be aligned by the vacuum collet 6. The vacuum collet 6 may suction the optical device 1 with a vacuum pressure 7. However, the vacuum collet 6 may cause damage to and alignment error of the optical device 1 due to changes in the vacuum pressure 7.

### SUMMARY

The present disclosure provides an optical alignment apparatus and an optical alignment method thereof which make it possible to increase precision, reliability, and productivity without damage to an optical device.

An embodiment of the inventive concept provides an optical alignment apparatus including: a substrate mount configured to receive a mounting substrate; a transport apparatus configured to transport an optical device to be bonded to the mounting substrate; a camera provided on the substrate mount and configured to obtain an image signal of the optical device; a controller connected to the camera and configured to control a position of the optical device using the image signal; and an adhesive block portion bonded to an upper surface of the optical device and configured to provide the optical device on the mounting substrate based on the transport apparatus and to be separated from optical device after bonding the mounting substrate and the optical device.

In an embodiment, the adhesive block portion may be transparent.

In an embodiment, the adhesive block portion may include: an adhesive block; and a cover surrounding a sidewall of the adhesive block.

In an embodiment, the adhesive block portion may further include: edge alignment patterns provided on the adhesive block and aligned with both edges of waveguides of the optical device; and center alignment patterns provided in the edge alignment patterns and aligned on the waveguides.

In an embodiment, the edge alignment patterns may each include opaque dotted line patterns.

In an embodiment, the center alignment patterns may include a transparent metal pattern.

In an embodiment, the adhesive block portion may further include blocking patterns provided on the center alignment patterns and aligned with electrodes of the optical device.

In an embodiment, the blocking patterns may include an opaque metal pattern.

In an embodiment, the substrate mount may have a first reflective film.

In an embodiment, the optical alignment apparatus may further include: a weight sensor provided on the transparent apparatus and configured to detect a weight of the optical device; and a support connected between the weight sensor and the adhesive block portion.

In an embodiment of the inventive concept, an optical alignment apparatus includes: a substrate mount configured to receive a mounting substrate; a transport apparatus configured to transport an optical device to be bonded to the mounting substrate; a support connected to the transparent apparatus; an adhesive block portion connected to the support and bonded to the optical device, and configured to be separated from the optical device by raising the support after bonding the optical device and the mounting substrate; a camera provided on the substrate mount and configured to obtain an image signal of the optical device; and a controller connected to the camera and configured to control a position of the optical device using the image signal.

In an embodiment, the adhesive block portion may include: a transparent adhesive block; and a cover surrounding a sidewall of the adhesive block.

In an embodiment, the adhesive block portion may further include: edge alignment patterns provided on the adhesive block and aligned with both edges of waveguides of the optical device; and center alignment patterns provided in the edge alignment patterns and aligned on the waveguides.

In an embodiment, the edge alignment patterns may each include opaque dotted line patterns, and the center alignment patterns may include a transparent metal pattern.

In an embodiment, the adhesive block portion may further include blocking patterns provided on the center alignment patterns and aligned with electrodes of the optical device, and the blocking patterns may include an opaque metal pattern.

In an embodiment of the inventive concept, an optical alignment method includes: providing an optical device on a substrate mount for receiving a mounting substrate using an adhesive block portion bonded to the optical device; aligning the optical device with the mounting substrate; bonding the optical device and the mounting substrate using an adhesive; and separating the adhesive block portion from the optical device by raising the adhesive block portion.

In an embodiment, the bonding of the optical device and the mounting substrate may include: providing the adhesive on the mounting substrate; providing the optical device on the adhesive; curing the adhesive by providing ultraviolet light to the adhesive; and separating the adhesive block portion from the optical device.

In an embodiment, the adhesive block portion may include: an adhesive block that transmits the ultraviolet light; and a cover surrounding a sidewall of the adhesive block.

In an embodiment, the adhesive block portion may further include: edge alignment patterns provided on the adhesive block and aligned with both edges of waveguides of the optical device; center alignment patterns provided in the edge alignment patterns and aligned on the waveguides; and blocking patterns provided on the center alignment patterns and aligned with electrodes of the optical device.

In an embodiment, the aligning of the optical device with the mounting substrate may be performed using an interference pattern of rays of light reflected from a first reflective film on the mounting substrate and a second reflective film on a lower surface of the optical device.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIGS. 1A and 1B are perspective views illustrating an example of bonding of typical optical devices;

FIGS. 2A and 2B are perspective views illustrating an example of bonding of typical optical devices;

FIGS. 3A and 3B are perspective views illustrating an example of a gripper for holding an optical device;

FIGS. 4A and 4B are perspective views illustrating an example of a vacuum collet for holding an optical device;

FIG. 5 is a cross-sectional view illustrating an example of an optical alignment apparatus according to the inventive concept;

FIGS. 6A and 6B are diagrams illustrating an example of an optical path and interference pattern of the first reflective film and the second reflective film of FIG. 5;

FIGS. 7A and 7B are diagrams illustrating a change in an interference pattern according to a position of the optical device of FIG. 6B;

FIGS. 8A to 8C are perspective views illustrating examples of the support part of FIG. 5;

FIGS. 9A to 9C are cross-sectional views illustrating an example of a storage substrate for storing the optical device of FIG. 5;

FIG. 10 is a cross-sectional view illustrating an example of the optical device of FIG. 5 and a mounting substrate for mounting the optical device;

FIGS. 11A to 11C are cross-sectional views illustrating an example of a bonding process of the mounting substrate and the optical device of FIG. 10;

FIG. 12 is a cross-sectional view illustrating an example of the first reflective film of FIG. 10;

FIG. 13 is a plan view illustrating an example of the adhesive block portion of FIG. 5;

FIG. 14 is a cross-sectional view taken along line I-I′ of FIG. 13;

FIG. 15 is a plan view illustrating an example of the adhesive block portion of FIG. 5; and

FIG. 16 is a cross-sectional view taken along line II-II′ of FIG. 15.

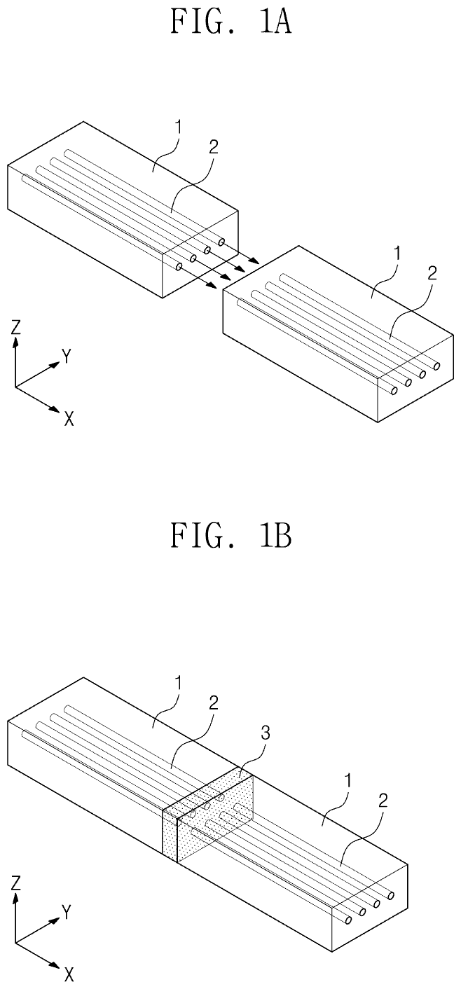

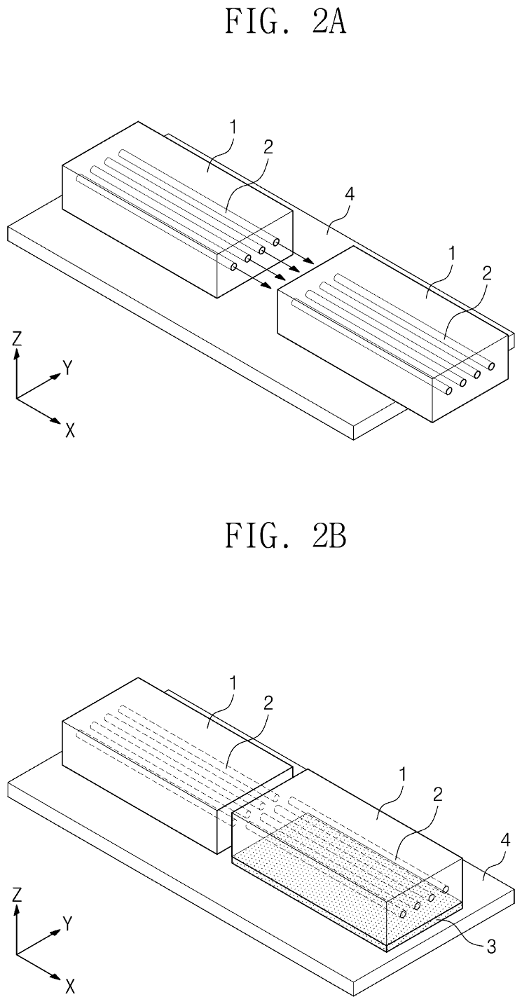

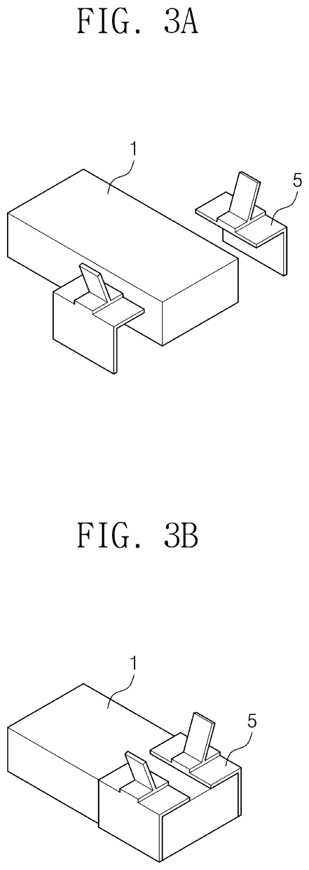

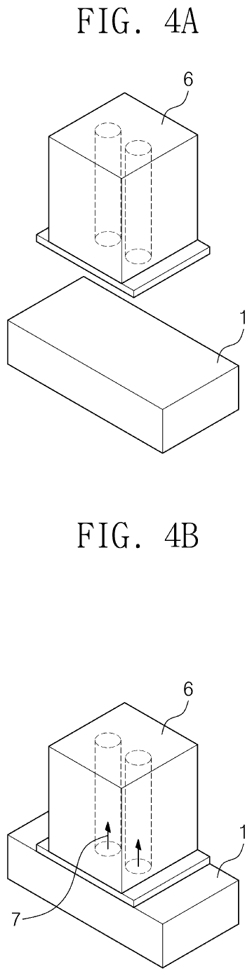

### DETAILED DESCRIPTION

Embodiments of the inventive concept will now be described in detail with reference to the accompanying drawings. Advantages and features of embodiments of the inventive concept, and methods for achieving the advantages and features will be apparent from the embodiments described in detail below with reference to the accompanying drawings. However, the inventive concept may be embodied in different forms and should not be construed as limited to the embodiments set forth herein. Rather, these embodiments are provided so that this disclosure will be thorough and complete, and will fully convey the scope of the inventive concept to those skilled in the art, and the inventive concept is only defined by the scope of the claims. Like reference numerals refer to like elements throughout.

The terminology used herein is not for delimiting the embodiments of the inventive concept but for describing the embodiments. The terms of a singular form may include plural forms unless otherwise specified. It will be further understood that the terms “includes”, “including”, “comprises”, and/or “comprising”, when used ‘in this description, specify the presence of stated elements, operations, and/or components, but do not preclude the presence or addition of one or more other elements, operations, and/or components. Furthermore, reference numerals, which are presented in the order of description, are provided according to the embodiments and are thus not necessarily limited to the order.

The embodiments of the inventive concept will be described with reference to example cross-sectional views and/or plan views. In the drawings, the dimensions of layers and regions are exaggerated for clarity of illustration. Therefore, the forms of the example drawings may be changed due to a manufacturing technology and/or error tolerance. Therefore, the embodiments of the inventive concept may involve changes of shapes depending on a manufacturing process, without being limited to the illustrated specific forms.

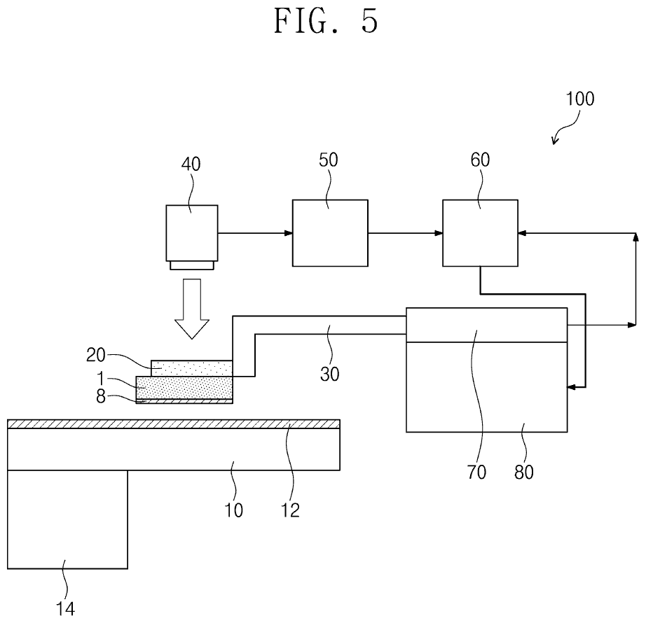

FIG. 5 illustrates an example of an optical alignment apparatus 100 according to the inventive concept.

Referring to FIG. 5, the optical alignment apparatus 100 according to the inventive concept may include a substrate mount 10, an adhesive block portion 20, a support part 30, a camera 40, a signal transmission part 50, a controller 60, a weight sensor 70, and a transport apparatus 80.

The substrate mount 10 may be provided under an optical device 1. The substrate mount 10 may be provided on a stage driving shaft 14 or a substrate support part According to an example, the substrate mount 10 may have a first reflective film 12. The first reflective film 12 may be provided on the substrate mount 10. The first reflective film 12 may reflect light. For example, the first reflective film 12 may include aluminum (Al) or tungsten (W), but the inventive concept is not limited thereto.

The adhesive block portion 20 may be provided on the first reflective film 12. The adhesive block portion 20 may hold the optical device 1 with an adhesive force. The adhesive block portion 20 may include a hexahedral block. According to an example, the adhesive block portion 20 may be transparent. The adhesive block portion 20 may project the optical device 1 onto the camera 40. For example, the adhesive block portion 20 may include transparent polydimethylsiloxane (PDMS). Although not illustrated, the adhesive block portion 20 may have an adhesive layer. The adhesive layer may be provided on a lower surface of the adhesive block portion 20. The adhesive layer may be bonded to an upper surface of the optical device 1.

The optical device 1 may be bonded to the adhesive block portion 20. The optical device 1 may include a multi-channel optical waveguide device. The optical device 1 may include an n-type or p-type clad. The optical device 1 may have a plurality of waveguides 2. The waveguides 2 may be provided in the optical device 1 and may be parallel to each other. The waveguides 2 may include an InGaAsP core. According to an example, the optical device 1 may have a second reflective film 8. The second reflective film 8 may be provided on a lower surface of the optical device 1. The second reflective film 8 may reflect light. The second reflective film 8 may include aluminum (Al) or tungsten (W), but the inventive concept is not limited thereto.

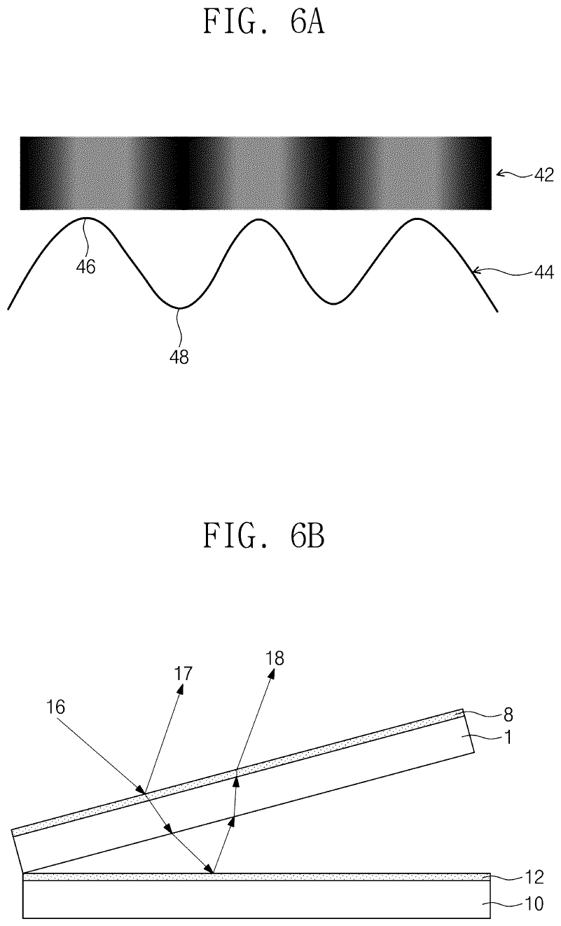

FIGS. 6A and 6B illustrate an example of an optical path and interference pattern of the first reflective film 12 and the second reflective film 8 of FIG. 5.

Referring to FIGS. 6A and 6B, when incident light 16 is provided on the first reflective film 12 and the second reflective film 8, the first reflective film 12 and the second reflective film 8 may reflect the incident light 16 and form an interference pattern 42. The first reflective film 12 may generate first reflective light 17 by reflecting the incident light 16. The second reflective film 8 may generate second reflected light 18 by reflecting transmitted light that has been transmitted to the first reflective film 12 and the optical device 1. The first reflected light 17 and the second reflected light 18 may interfere with each other and generate the interference pattern 42. The interference pattern 42 may be displayed as a light intensity 44 according to a constructive interference 46 and a destructive interference 48.

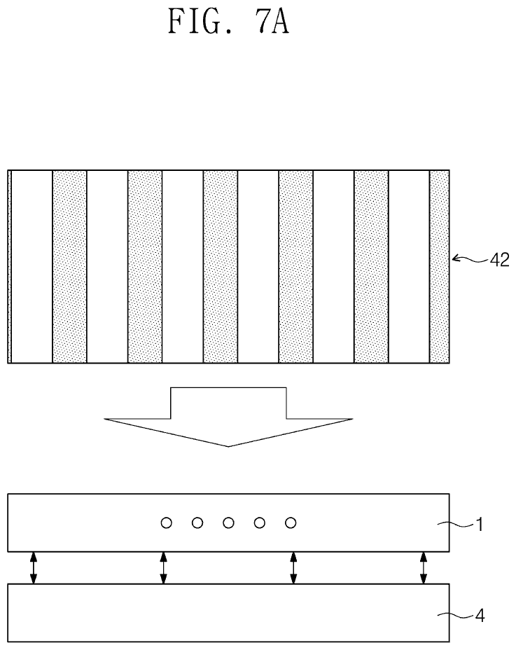

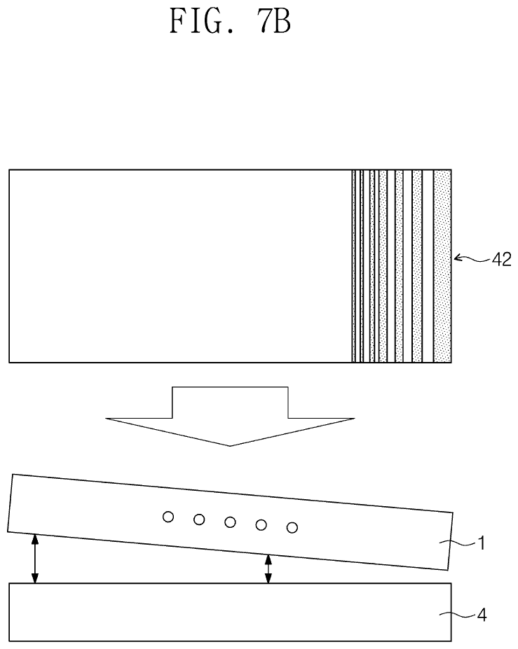

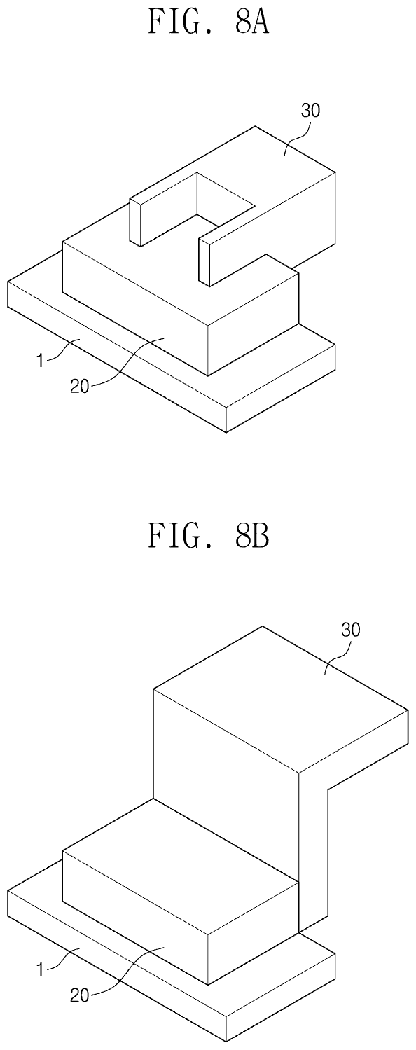

FIGS. 7A and 7B illustrate a change in an interference pattern according to a position of the optical device 1 of FIG. 6B.

Referring to FIGS. 7A and 7B, the interference pattern 42 may be changed on the basis of the position of the optical device 1 relative to the substrate mount 10.

Referring to FIG. 7A, when the optical device 1 is parallel to the substrate mount 10, the interference pattern 42 may be shown in a shape of stripes spaced a certain distance apart.

Referring to FIG. 7B, when the optical device 1 is inclined with respect to the substrate mount 10, the interference pattern 42 may be shown in a shape of stripes that become denser toward one side.

Referring back to FIG. 5, the support part 30 may be connected to a sidewall of one side of the adhesive block portion 20. The support part 30 may support the adhesive block portion 20. The support part 30 may be connected to the weight sensor 70 and the transport apparatus 80. The support part 30 may transport the adhesive block portion 20 using the transport apparatus 80. The support part 30 may include a robot arm, but the inventive concept is not limited thereto.

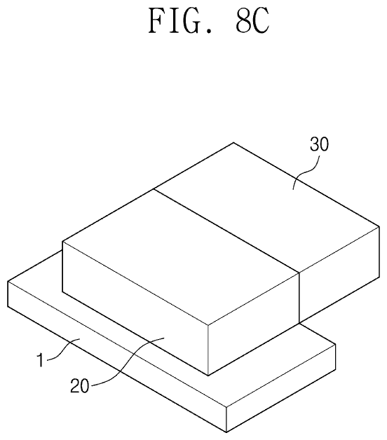

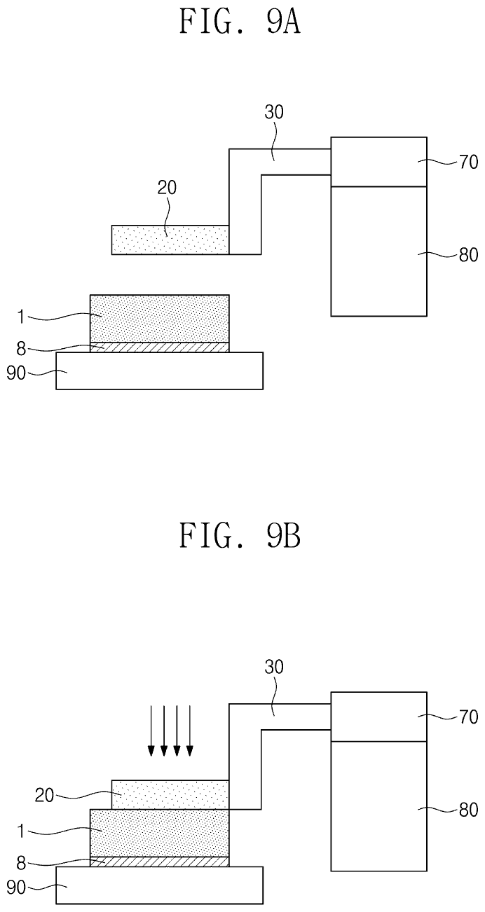

FIGS. 8A to 8C illustrate examples of the support part 30 of FIG. 5.

Referring to FIGS. 8A to 8C, the support part 30 may be provided to a portion of an upper surface or a sidewall of the adhesive block portion 20. For example, the support part 30 may have a shape of a fork, angle bracket, or straight line.

Referring back to FIG. 5, the camera 40 may be provided on the substrate mount 10 and the adhesive block portion 20. The camera 40 may generate an image signal of the substrate mount 10 and the adhesive block portion 20.

The signal transmission part 50 may be connected between the camera 40 and the controller 60. The signal transmission part 50 may transmit an image signal of the camera 40 to the controller 60. For example, the signal transmission part 50 may include an A/D converter. Alternatively, the signal transmission part 50 may include a pattern recognition part or pattern recognition sensor, but the inventive concept is not limited thereto.

The controller 60 may receive the image signal and obtain an image of the substrate 10 and the optical device 1. The controller 60 may align the optical device 1 on the substrate mount 10.

The weight sensor 70 may be connected between the transport apparatus 80 and the support part 30. The weight sensor 70 may detect a weight of the optical device 1. The controller 60 may determine whether the substrate mount 10 is in contact with the optical device 1 or the mounting substrate 4 is in contact with the optical device 1 using a weight detection signal of the optical device 1. For example, the weight sensor 70 may include a pressure sensor or PZT sensor, but the inventive concept is not limited thereto.

The transport apparatus 80 may be connected to the support part 30 through the weight sensor 70. The transport apparatus 80 may move the optical device 1 horizontally and vertically. The transport apparatus 80 may include a robot driving part or driving shaft, but the inventive concept is not limited thereto.

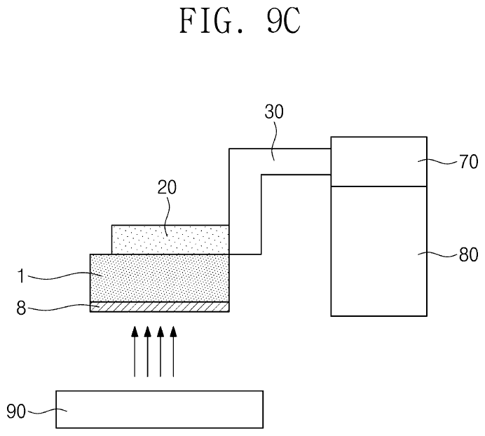

FIGS. 9A to 9C illustrate an example of a storage substrate 90 for storing the optical device 1 of FIG. 5.

Referring to FIGS. 9A to 9C, the storage substrate 90 may be provided under the optical device 1 and store the optical device 1.

The support part 30 and the transport apparatus 80 may press the adhesive block portion 20 against the upper surface of the optical device 1 and raise the adhesive block portion 20. The optical device 1 may be bonded to the adhesive block portion 20 and separated from the storage substrate 90. Although not illustrated, the transport apparatus 80, the support part 30, and the adhesive block portion 20 may provide the optical device 1 on the substrate mount 10.

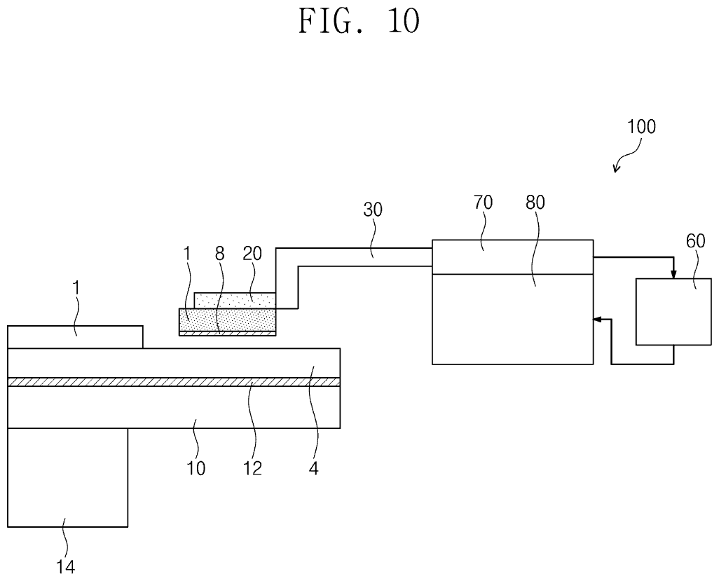

FIG. 10 illustrates examples of the optical device 1 and the mounting substrate 4 for mounting the optical device 1.

Referring to FIG. 10, the optical alignment apparatus 100 may provide the optical device 1 on one side of the mounting substrate 4 on the substrate mount 10. The mounting substrate 4 may be provided on the substrate mount 10 and the first reflective film 12. Another optical device 1 may be bonded in advance onto the other side of the mounting substrate 4. The controller 60 may perform a surface alignment process on the optical device 1 and the waveguides 2 using the interference pattern 42 (FIGS. 7A and 7B) of the first reflective film 12 and the second reflective film 8.

Therefore, the optical alignment apparatus 100 may align the optical device 1 using the interference pattern 42 of the first reflective film 12 and the second reflective film 8.

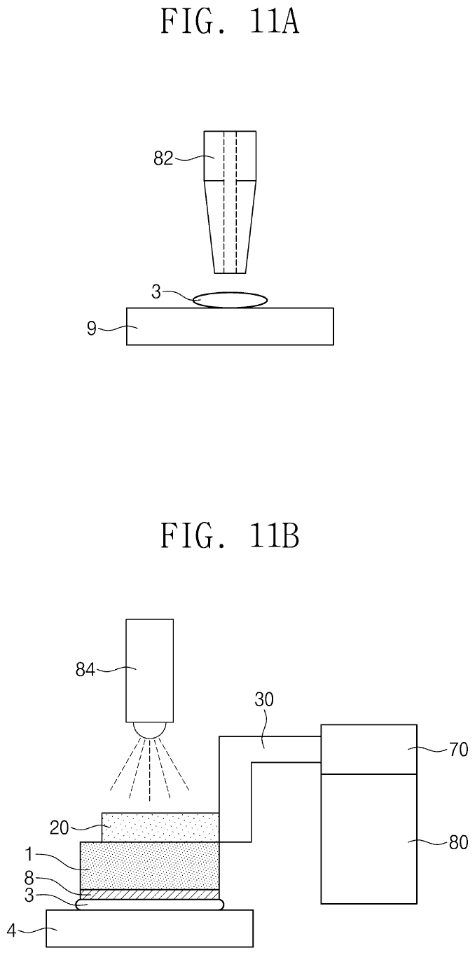

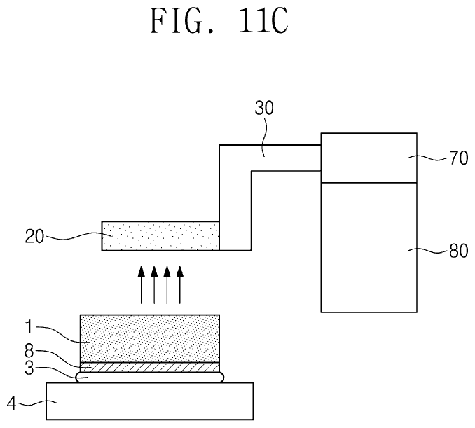

FIGS. 11A to 11C illustrate an example of a bonding process of the mounting substrate 4 and the optical device 1 of FIG. 10.

Referring to FIG. 11A, an adhesive application apparatus 82 may provide the adhesive 3 on the mounting substrate 4. The adhesive application apparatus 82 may include an adhesive nozzle, but the inventive concept is not limited thereto. The adhesive 3 may include epoxy or resin, but the inventive concept is not limited thereto.

Referring to FIG. 11B, a light source 84 may provide ultraviolet light to the adhesive 3 to cure the adhesive 3. The ultraviolet light may be transmitted to the adhesive block portion 20 and the optical device 1. The ultraviolet light may cure the adhesive 3. The adhesive 3 may bond and fix the optical device 1 to the mounting substrate 4. Alternatively, the light source 84 may provide visible light or infrared light to the adhesive 3 to cure the adhesive 3. Although not illustrated, the adhesive 3 may be cured through a heat treatment, but the inventive concept is not limited thereto.

Referring to FIG. 11C, the transport apparatus 80 may raise the adhesive block portion 20, and the adhesive block portion 20 may be separated from the optical device 1. An adhesive force of the adhesive 3 may be higher than an adhesive force between the optical device 1 and the adhesive block portion 20.

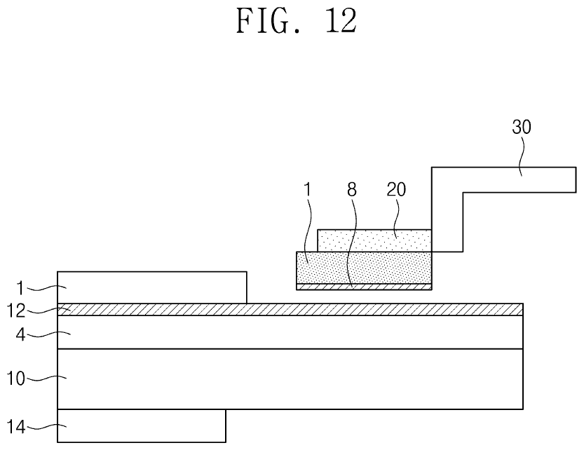

FIG. 12 illustrates an example of the the first reflective film 12 of FIG. 10.

Referring to FIG. 12, the first reflective film 12 may be provided on the mounting substrate 4. The first reflective film 12 may be provided between the mounting substrate 4 and the optical device 1. When the optical device 1 is placed on the mounting substrate 4, the second reflective film 8 may be in contact with the first reflective film 12.

The substrate mount 10, the mounting substrate 4, the optical device 1, the adhesive block portion 20, and the support part 30 may be configured in the same manner as illustrated in FIG. 10.

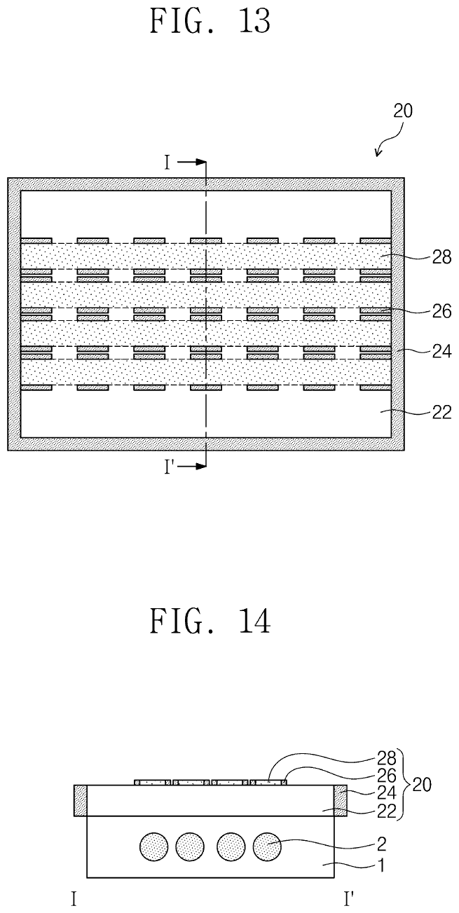

FIG. 13 illustrates an example of the adhesive block portion 20 of FIG. 5. FIG. 14 is a cross-sectional view taken along line I-I′ of FIG. 13.

Referring to FIGS. 13 and 14, the adhesive block portion 20 may include an adhesive block 22, a cover 24, edge alignment patterns 26, and center alignment patterns 28.

The adhesive block 22 may be provided in the cover 24. The adhesive block 22 may be provided on the optical device 1. The adhesive block 22 may be aligned on the optical device 1. The adhesive block 22 may include PDMS. The adhesive block 22 may have an adhesive layer. The adhesive layer may be provided on a lower surface of the adhesive block 22.

The cover 24 may surround a sidewall of the adhesive block 22. The cover 24 may have a shape of a quadrangle or square in a plan view.

The edge alignment patterns 26 may be provided on the adhesive block 22. The edge alignment patterns 26 may be aligned with a border or outer circumferential surface of the optical waveguides 2. The edge alignment patterns 26 may be waveguide contour patterns. Alternatively, the edge alignment patterns 26 may overlap the border or outer circumferential surface of the optical waveguides 2. The edge alignment patterns 26 may each have a shape of a rectangle in a plan view. The edge alignment patterns 26 may each include opaque dotted lines. For example, the edge alignment patterns 26 may include opaque metal such as chromium (Cr) or iron, but the inventive concept is not limited thereto.

The center alignment patterns 28 may be provided in the edge alignment patterns 26. The center alignment patterns 28 may be aligned on the optical waveguides 2. Alternatively, the center alignment patterns 28 may overlap the optical waveguides 2, but the inventive concept is not limited thereto. The center alignment patterns 28 may have a shape of a rectangle in a plan view. The center alignment patterns 28 may include a transparent metal pattern formed of indium tin oxide (ITO).

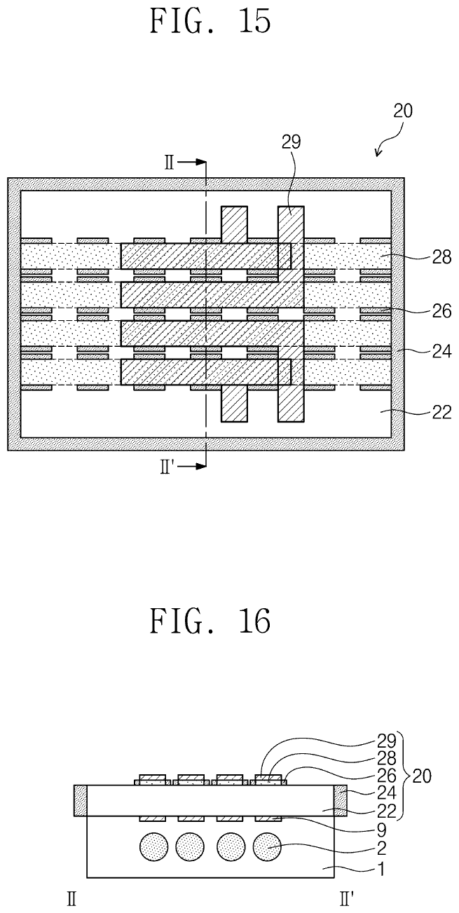

FIG. 15 illustrates an example of the adhesive block portion 20 of FIG. 5. FIG. 16 is a cross-sectional view taken along line II-II′ of FIG. 15.

Referring to FIGS. 15 to 16, the adhesive block portion 20 may further include blocking patterns 29. The adhesive block 22, the cover 24, the edge alignment patterns 26, and the center alignment patterns 28 may be configured in the same manner as illustrated in FIGS. 13 and 14.

The blocking patterns 29 may be provided on the center alignment patterns 28. The blocking patterns 29 may be provided on electrodes 9 of the optical device 1. The blocking patterns 29 may prevent damage to the light source 84 by preventing reflection of ultraviolet light. The blocking patterns 29 may include an opaque metal pattern formed of chromium (Cr).

The electrodes 9 may be provided on the optical waveguides 2 of the optical device 1 and adjust an effective refractive index of the optical waveguides (2). The electrodes 9 may tune a wavelength or phase of light in the optical waveguides 2. When the light source 84 provides ultraviolet light to the electrodes 9, the electrodes 9 may damage the light source 84 by reflecting the ultraviolet light to the light source 84. The blocking patterns 29 may protect the light source 84 by absorbing the ultraviolet light.

An optical alignment apparatus and an optical alignment method thereof according to an embodiment of the inventive concept may make it possible to increase precision, reliability, and productivity without damage to an optical device by using an adhesive block portion for bonding the optical device to a mounting substrate. Unlike clamps and vacuum collets, the adhesive block portion of an embodiment of the inventive concept may fix an optical element without physically damaging it. The adhesive block portion may provide optical visibility to realize real-time confirmation of an alignment pattern and accurate position control.

Although the embodiments of the present invention have been described, it is understood that the present invention should not be limited to these embodiments but various changes and modifications can be made by one ordinary skilled in the art within the spirit and scope of the present invention as hereinafter claimed.

What is claimed is:

1. An optical alignment apparatus comprising:
a substrate mount configured to receive a mounting substrate;
a transport apparatus configured to transport an optical device to be bonded to the mounting substrate;
a camera provided on the substrate mount and configured to obtain an image signal of the optical device;
a controller connected to the camera and configured to control a position of the optical device using the image signal; and
an adhesive block portion bonded to an upper surface of the optical device and configured to provide the optical device on the mounting substrate based on the transport apparatus and to be separated from optical device after bonding the mounting substrate and the optical device.

2. The optical alignment apparatus of claim 1, wherein the adhesive block portion is transparent.

3. The optical alignment apparatus of claim 1, wherein the adhesive block portion includes:
an adhesive block; and
a cover surrounding a sidewall of the adhesive block.

4. The optical alignment apparatus of claim 3, wherein the adhesive block portion further includes:
edge alignment patterns provided on the adhesive block and aligned with both edges of waveguides of the optical device; and
center alignment patterns provided in the edge alignment patterns and aligned on the waveguides.

5. The optical alignment apparatus of claim 4, wherein the edge alignment patterns each include opaque dotted line patterns.

6. The optical alignment apparatus of claim 4, wherein the center alignment patterns include a transparent metal pattern.

7. The optical alignment apparatus of claim 4, wherein the adhesive block portion further includes blocking patterns provided on the center alignment patterns and aligned with electrodes of the optical device.

8. The optical alignment apparatus of claim 7, wherein the blocking patterns include an opaque metal pattern.

9. The optical alignment apparatus of claim 1, wherein the substrate mount has a first reflective film.

10. The optical alignment apparatus of claim 1, further comprising:
a weight sensor provided on the transparent apparatus and configured to detect a weight of the optical device; and
a support connected between the weight sensor and the adhesive block portion.

11. An optical alignment apparatus comprising:
a substrate mount configured to receive a mounting substrate;
a transport apparatus configured to transport an optical device to be bonded to the mounting substrate;
a support connected to the transparent apparatus;
an adhesive block portion connected to the support and bonded to the optical device, and configured to be separated from the optical device by raising the support after bonding the optical device and the mounting substrate;
a camera provided on the substrate mount and configured to obtain an image signal of the optical device; and
a controller connected to the camera and configured to control a position of the optical device using the image signal.

12. The optical alignment apparatus of claim 11, wherein the adhesive block portion includes:
a transparent adhesive block; and
a cover surrounding a sidewall of the adhesive block.

13. The optical alignment apparatus of claim 12, wherein the adhesive block portion includes:
edge alignment patterns provided on the adhesive block and aligned with both edges of waveguides of the optical device; and
center alignment patterns provided in the edge alignment patterns and aligned on the waveguides.

14. The optical alignment apparatus of claim 13, wherein the edge alignment patterns each include opaque dotted line patterns, and the center alignment patterns include a transparent metal pattern.

15. The optical alignment apparatus of claim 14,
wherein the adhesive block portion further includes blocking patterns provided on the center alignment patterns and aligned with electrodes of the optical device, and
the blocking patterns include an opaque metal pattern.

16. An optical alignment method comprising:
providing an optical device on a substrate mount for receiving a mounting substrate using an adhesive block portion bonded to the optical device;
aligning the optical device with the mounting substrate;
bonding the optical device and the mounting substrate using an adhesive; and
separating the adhesive block portion from the optical device by raising the adhesive block portion.

17. The optical alignment method of claim 16, wherein the bonding of the optical device and the mounting substrate includes:
providing the adhesive on the mounting substrate;
providing the optical device on the adhesive;
curing the adhesive by providing ultraviolet light to the adhesive; and
separating the adhesive block portion from the optical device.

18. The optical alignment method of claim 17, wherein the adhesive block portion includes:
an adhesive block that transmits the ultraviolet light; and
a cover surrounding a sidewall of the adhesive block.

19. The optical alignment method of claim 18, wherein the adhesive block portion further includes:
edge alignment patterns provided on the adhesive block and aligned both edges of waveguides of the optical device;
center alignment patterns provided in the edge alignment patterns and aligned on the waveguides; and
blocking patterns provided on the center alignment patterns and aligned with electrodes of the optical device.

20. The optical alignment method of claim 16, wherein the aligning of the optical device with the mounting substrate is performed using an interference pattern of rays of light reflected from a first reflective film on the mounting substrate and a second reflective film on a lower surface of the optical device.
